(19) United States
(12) Patent Application Publication
(10) Pub. No.: US 2005/0107511 A1
(43) Pub. Date: May 19, 2005

(54) Utilization of oxidized polyolefin waxes for textile finishing

(76) Inventors: Gerd Hohner, Gersthofen (DE); Ernst Stalmann, Augsburg (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/504,500

(22) PCT Filed: Feb. 4, 2003
(86) PCT No.: PCT/EP03/01058

(30) Foreign Application Priority Data
Feb. 14, 2002 (DE) 102-06-015.0

(51) Int. Cl. C08J 3/00

(52) U.S. Cl. 524/487; 524/543

(57) ABSTRACT

The invention relates to the utilization of oxidized polyolefin that are produced with the aid of metallocene catalysts for textile finishing.

The present invention relates to the use of oxidized polyolefinic waxes.

The final finishing of textile yarns, wovens and knits in cellulosic fibers, wool, synthetic fibers and blends thereof with softeners based on soft or hard polyethylene waxes is established practice in today's textile industry. Aqueous dispersions of oxidized polyethylenic waxes are used in particular.

As well as providing a softening, hand-improving effect, textile softeners have to perform other functions. The melamine resins frequently used in textile finishing to provide crease resist and easy care properties have an appreciably adverse effect on hand, sewing and soil release performance. This adverse effect is substantially compensated by modern softeners based on polar polyethylenic waxes. To reduce costs and labor at final textile finishing, the polyethylene wax dispersions have to be compatible with the melamine derivatives in order that they may be applied from one aftertreating bath. It is here that the hard, high molecular weight polar polyethylenic waxes having a number average molecular weight (Mn) above 2000 g/mol have distinctly better properties as an active substance than low molecular weight, soft polar polyethylenic waxes.

The disadvantage with hard polyethylene wax oxidates of high molecular weight is the high cost and inconvenience needed to emulsify them. The emulsification has to be carried out in a sealed autoclave at temperatures of 135-155° C. This not only takes more time but also requires higher energy costs and also a high consumption of cooling water to cool the ready-produced dispersion down to room temperature.

It has now been found that oxidized waxes based on polyethylene waxes produced using metallocene catalysts are very useful as textile softeners and combine this usefulness with the advantage of ready emulsifiability at low temperatures.

The invention accordingly provides for the use for textile finishing of oxidized polyolefinic waxes produced using metallocene catalysts.

The polyolefinic waxes used are preferably ethylene homo- or copolymer waxes including 0-30% by weight of an olefin comonomer having a chain length of 3-18 carbon atoms.

The olefin comonomers used are preferably propene, 1-butene, 1-hexene, 1-octene, 1-octadecene or styrene.

The oxidized polyolefinic waxes preferably have a drop point of 85 to 127° C.

The oxidized polyolefinic waxes more preferably have a drop point of 90 to 120° C.

The oxidized polyolefinic waxes preferably have a melt viscosity (at 140° C.) of 10 to 10000 mPa·s.

The oxidized polyolefinic waxes more preferably have a melt viscosity (at 140° C.) of 20 to 5000 mPa·s.

The oxidized polyolefinic waxes especially have a melt viscosity (at 140° C.) of 30 to 2000 mPa·s.

The oxidized polyolefinic waxes preferably have a density of 0.89 to 1.00 g/cm³.

The oxidized polyolefinic waxes more preferably have a density (at 20° C.) of 0.91 to 0.98 g/cm³.

The oxidized polyolefinic waxes preferably have acid numbers between 14 and 30 mg KOH/g.

The oxidized polyolefinic waxes more preferably have acid numbers between 16 and 25 mg KOH/g.

The oxidized polyolefinic waxes are preferably used in the form of aqueous dispersions.

In summary, the oxidized polyolefinic waxes have drop points of 85 to 125° C. and preferably of 90 to 120° C., melt viscosities measured at 140° C. of 10 to 10 000 mPa·s, preferably of 20 to 5000 mPa·s and especially of 30 to 2000 mPa·s, densities (at 20° C.) of 0.89 to 1.00 g/cm³ and preferably of 0.91 to 0.98 g/cm³ and acid numbers between 14 and 30 mg KOH/g and preferably between 16 and 25 mg KOH/g.

Useful starting materials for the oxidized waxes are homopolymers of ethylene or copolymers of ethylene with one or more 1-olefins. The 1-olefins used are linear or branched olefins having 3-18 carbon atoms and preferably 3-6 carbon atoms. Examples thereof are propene, 1-butene, 1-hexene, 1-octene or 1-octadecene, also styrene. Preference is given to copolymers of ethylene with propene or 1-butene. The copolymers are 70-99.9% and preferably 80-99% by weight ethylene.

Polyolefinic waxes which are particularly useful have a drop point between 90 and 130° C. and preferably between 100 and 127° C., a melt viscosity at 140° C. between 10 and 10 000 mPa·s and preferably between 20 and 5000 mPa·s and a density at 20° C. between 0.89 and 0.98 cm³/g and preferably between 0.90 and 0.97 cm³/g.

Metallocene catalysts for producing the polyolefinic waxes are chiral or nonchiral transition metal compounds of the formula M¹Lₓ. The transition metal compound M¹Lₓ includes at least one central metal atom M¹ to which at least one π-ligand, for example a cyclopentadienyl ligand, is attached. In addition, substituents such as for example halo, alkyl, alkoxy or aryl groups can be attached to the central metal atom M¹. M¹ is preferably an element of the III^{rd}, IV^{th}, V^{th} or VI^{th} main group of the Periodic Table of the Elements, such as titanium, zirconium or hafnium. Cyclopentadienyl ligand refers to unsubstituted cyclopentadienyl radicals and substituted cyclopentadienyl radicals such as methylcyclopentadienyl, indenyl, 2-methylindenyl, 2-methyl-4-phenylindenyl, tetrahydroindenyl or octahydrofluorenyl radicals. The π-ligands can be bridged or unbridged, in which case single bridging and multiple bridging—including via ring systems—are possible. Metallocene also comprehends compounds having more than one metallocene fragment, so-called polynuclear metallocenes. These can comprise any desired substitution patterns and bridging variants. The individual metallocene fragments of such polynuclear metallocenes can be similar to or dissimilar from each other. Examples of such polynuclear metallocenes are described for example in EP 0 632 063 A2.

Examples of general structural formulae of metallocenes and also of their use for producing olefin homo- and copolymer waxes are indicated inter alia in EP 0 571 882 A2.

Oxidation of thus produced waxes in the melt by means of oxygen or oxygen-including gas mixtures by known processes, for instance according to EP 0 896 591 A2 or according to EP 0 890 583 A2, provides polar waxy oxidates.

Textile finishing as per the present invention preferably utilizes oxidates of ethylene homopolymer waxes having acid numbers between 14 and 30 mg KOH/g, drop points between 90 and 120° C. and melt viscosities (measured at 140° C.) between 20 and 5000 mPa·s.

To be used for textile finishing, the oxidized polyolefinic waxes are pressure emulsified in water in a known manner using nonionic, anionic or cationic emulsifiers.

### EXAMPLES

The melt viscosities of the waxes described hereinbelow were determined in accordance with DGF-M-III 8 (57) using a rotary viscometer, the drop points in accordance with DGF-M-III 3 (75), the needle penetration numbers in accordance with DGF-M-III 9b (95), the acid numbers in accordance with DGF-M-IV 2 (57) (the DGF standards are standards of the German Society of Fat Science), the densities in accordance with DIN 53479.

The inventive examples utilized two waxy oxidates (W1/1 and W1/2) which were obtained by air oxidation of the metallocene-catalytically synthesized polyethylene waxes E1/1 and E1/2. The latter were produced by homopolymerization of ethylene in accordance with Example 2 of EP 0 571 882 A2 using bis(indenyl)zirconium dichloride as a catalyst and methylalumoxane as a cocatalyst, and had the following properties:

TABLE 1

| | E1/1 | E1/2 |
|---|---|---|
| Melt viscosity/140° C./mPa · s | 190 | 630 |
| Drop point/° C. | 124 | 125 |
| Density/g/cm³ | 0.973 | 0.970 |
| Needle penetration number/0.1 mm | <1 | <1 |

The conversion to the oxidates W1/1 and W1/2 (table 2) was carried out with air in the melt according to Example 1 of EP 0 890 583 A2.

The comparative examples utilized the oxidates W2-W4 from raw materials produced without metallocene catalysts.

TABLE 2

| | W1/1 | W1/2 | | W 3 | |
|---|---|---|---|---|---|
| | Oxidate | Oxidate | W 2 | Licowax | |
| | from | from | Oxidate | PED 821 | |
| | metallocene | metallocene | from | (from | W 4 |
| | PE wax | PE wax | Ziegler | Clariant | A-C 330 |
| | E1/1 | E1/2 | PE wax | GmbH, | (from Honeywell) |
| Viscosity/ | 140 | 350 | 200 | 180 | 3460 |
| 140° C. mPa · s | | | | | |
| Drop point/° C. | 115 | 116 | 114 | 106 | 130 |
| Needle | 2 | 2 | 1-2 | 4 | 1 |
| penetration | | | | | |
| in 1/10 mm | | | | | |
| Acid number | 18 | 19 | 18 | 16 | 28 |
| mg KOH/g | | | | | |
| Density at | 0.97 | 0.97 | 0.98 | 0.95 | 0.99 |
| 20° C. g/cm³ | | | | | |

The oxidates W1/1, W1/2 and W2-W4 were used to prepare aqueous dispersions by employing the following emulsifiers:

Emulsifier 1: Synperonic 13/12 (ICI): tridecanol, ethoxylated with 12 mol of ethylene oxide.

Emulsifier 2: Genapol OX-100 (Clariant): polyglycol ether based on a synthetic C₁₂-C₁₅ oxo alcohol ethoxylated with 10 mol of ethylene oxide.

Table 3 gives the recipe constituents used to prepare the wax dispersions D1/1-D4 in parts by weight. The emulsifier was dissolved in hot deionized water at about 50° C. and introduced into an autoclave together with wax, potassium hydroxide, sodium pyrosulfite and water. This was followed by heating to 115° C. over 20 min, stirring at 115° C. for 20 min and then cooling down to room temperature over 35 min. The stirrer speed was 200 revolutions per min.

TABLE 3

| | D1/1 | D1/2 | D 2 | D 3 | D 4 |
|---|---|---|---|---|---|
| W1/1 | 27 | — | — | — | — |
| W1/2 | — | 27 | | — | — |
| W2 | — | — | 27 | — | — |
| W3 | — | — | — | 27 | — |
| W4 | — | — | — | — | 27 |
| Emulsifier 1 | 7 | 7 | 7 | 7 | 7 |
| KOH (86%) | 0.5 | 0.5 | 0.5 | 0.5 | 0.5 |
| Na pyrosulfite | 0.3 | 0.3 | 0.3 | 0.3 | 0.3 |
| Deionized water | 65.2 | 65.2 | 65.2 | 65.2 | 65.2 |
| Appearance of | fine | fine | dispersion | fine | wax |
| dispersion | transparent | transparent | is solid | transparent | has not melted |
| | dispersion, | dispersion, | | dispersion, | |
| | liquid LT | liquid LT | | liquid LT | |
| | 70% | 73% | | 68% | |

Each polyethylene wax dispersion was rated for quality on the basis of its light transmission (LT) as measured using an LT 12/transparency meter from Dr. Lange for a 2 mm cuvette.

The polyethylene wax dispersion used for textile-engineering applications should have a light transmission of >50%. This requirement was only met by the polyethylene wax oxidates W1/1 and W1/2 from metallocene wax and also by the relatively soft polyethylene wax oxidate W3. The waxes which were not emulsifiable under formulations D2 and D4 were emulsified by recipes modified compared with the above procedure (table 4). The polyethylene wax dispersions thus produced showed the required transparency of >50%.

TABLE 4

| | D5 | D6 |
|---|---|---|
| W2 | 27.0 | — |
| W4 | — | 27.0 |
| Emulsifier 1 | 7.0 | — |
| Emulsifier 2 | — | 8.0 |
| KOH (86%) | 0.5 | 0.5 |
| Sodium pyrosulfite | 0.3 | 0.2 |
| Deionized water | 65.2 | 64.3 |
| Emulsifying | 135° C. | 155° C. |
| temperature | | |
| Appearance of | fine transparent | fine transparent dispersion |
| dispersion | dispersion liquid | slightly viscous |
| Light transmission | >50% | >50% |

Textile aftertreating liquors N1/1-N4 were produced by, in each case, stirring 20 g of the polyethylene wax dispersions D1/1, D1/2, D3, D5 and D6 respectively in deionized water together with the synthetic resin product Arkofix NDF konz. (modified N-methyloldihydroxyethyleneurea, commercial product of Clariant GmbH) for a wash and wear finish and the 3282 catalyst needed to crosslink the synthetic resin finish (catalyst based on metal salt, commercial product of Clariant GmbH) and also with 0.5 g of acetic acid and made up to 1 I.

The thus produced aftertreating liquors N1/1-N4 were padded at room temperature onto bleached cotton knit at a wet pickup of 70% using a laboratory pad-mangle, subsequently dried at 100° C. for 2 min and cured at 150° C. for 3 min.

The cotton knit aftertreated by this application method with the 5 polyethylene wax dispersions D1/1, D1/2, D3, D5 and D6 exhibited the following textile-engineering properties (table 5):

TABLE 5

| | | | D3 | D5 | D6 |
|---|---|---|---|---|---|
| Wax dispersions | D1/1 | D1/2 | (comp) | (comp) | (comp) |
| Aftertreating liquor | N1/1 | N1/2 | N2 | N3 | N4 |
| Soft hand | very | very | good | good | very |
| | good | good | | | good |
| Soil release | very | very | good | bad | very |
| | good | good | | | good |
| Sewing properties: | | | | | |
| Needle gauge NM 100 | 5-10 | 5-10 | 5-10 | 15-25 | 5-10 |
| Needle gauge NM 90 | ca. 2 | ca. 2 | ca. 2 | 7-12 | ca. 2 |
| Needle gauge NM 80 | 0 | 0 | 0 | ca. 2 | 0 |

The values reported under “sewing properties” indicate the number of sewing defects per 50 cm of cotton knit. The testing was carried out using 3 different needle gauges at a sewing speed of 3000 stitches/minute.

1. A textile finishing agent comprising an oxidized polyolefinic wax produced using at least one metallocene catalyst.

2. The textile finishing agent according to claim 1, wherein the polyolefinic wax is an ethylene homo- or copolymer wax including 0% to 30% by weight of an olefin comonomer having a chain length of 3 to 18 carbon atoms.

3. The textile finishing agent according to claim 2, wherein the olefin comonomer is selected from the group consisting of propene, 1-butene, 1-hexene, 1-octene, 1-octadecene and styrene.

4. The textile finishing agent according to claim 1, wherein the oxidized polyolefinic wax has a drop point of 85 to 125° C.

5. The textile finishing agent according to claim 1, wherein the oxidized polyolefinic wax has a drop point of 90 to 120° C.

6. The textile finishing agent according to claim 1, wherein the oxidized polyolefinic wax has a melt viscosity at 140° C. of 10 to 10 000 mPa·s.

7. The textile finishing agent according to claim 1, wherein the oxidized polyolefinic wax has a melt viscosity at 140° C. of 20 to 5000 mPa·s.

8. The textile finishing agent according to claim 1, wherein the oxidized polyolefinic wax has a melt viscosity at 140° C. of 30 to 2000 mPa·s.

9. The textile finishing agent according claim 1, wherein the oxidized polyolefinic wax has a density at 20° C. of 0.89 to 1.00 g/cm³.

10. The textile finishing agent according to claim 1, wherein the oxidized polyolefinic wax has a density at 20° C. of 0.91 to 0.98 g/cm³.

11. The textile finishing agent according to claim 1, wherein the oxidized polyolefinic wax has an acid number between 14 and 30 mg KOH/g.

12. The textile finishing agent according to claim 1, wheein the oxidized polyolefinic wax has an acid number between 16 and 25 mg KOH/g.

13. The textile finishing agent according to claim 1, wherein the oxidized polyolefinic wax is used in the form of an aqueous dispersion.

14. A process for finishing a textile comprising the step of applying a textile finishing agent to the textile, wherein the textile finishing agent includes an oxidized polyolefinic wax produced using at least one metallocene catalyst.

15. A finished textile made in accordance with the process of claim 14.
